(19) United States
(12) Patent Application Publication
(10) Pub. No.: US 2016/0369060 A1
(43) Pub. Date: Dec. 22, 2016

(54) COMPOSITION FOR COMPOSITE SHEET, COMPOSITE SHEET MANUFACTURED USING SAME, AND DISPLAY DEVICE COMPRISING SAME

(71) Applicant: SAMSUNG SDI CO., LTD., Yongin-si (KR)

(72) Inventors: Woo Jin LEE, Uiwang-si (KR); Eun Hwan JEONG, Uiwang-si (KR); Sung Kook KIM, Uiwang-si (KR); Young Kwon KIM, Uiwang-si (KR); Jae cheol CHO, Uiwang-si (KR)

(21) Appl. No.: 14/900,582

(22) PCT Filed: Jul. 28, 2014
(86) PCT No.: PCT/KR2014/006885

§ 371 Date: Dec. 21, 2015

(30) Foreign Application Priority Data
Sep. 25, 2013 (KR) 10-2013-0114117

(51) Int. Cl. C08G 77/20; B32B 25/20; B32B 25/02; C08G 77/00; C08K 7/14

(52) U.S. Cl. CPC C08G 77/20; C08G 77/80; C08K 7/14; B32B 25/02; B32B 25/20; B32B 2307/54; B32B 2457/20; B32B 2262/101

(57) ABSTRACT

The present invention relates to: a composition for a composite sheet comprising linear silicone-based rubber and a crosslinking agent, wherein a matrix made of the composition has a tensile elongation of about 15% or greater; a composite sheet manufactured using the same; and a display device comprising the same.

### TECHNICAL FIELD

The present invention relates to a composition for composite sheets, a composite sheet prepared from the same and a display apparatus comprising the same.

### BACKGROUND

Materials of substrate for display apparatuses are required for miniaturization, thinning, weight lightening, impact resistance, flexibility, and the like. Therefore, the substrate for flexible displays as materials for replacing the glass substrate of the conventional display apparatus has been interested.

A composite sheet, in which a woven form of the glass fiber is impregnated as a reinforcing material may be used as the substrate for flexible displays. Conventionally, the composite sheet has been prepared by impregnating the woven form of the glass fiber in the composition for composite sheets of silicone materials and curing, and there are problems on the control of elongation and modulus. In addition, there are problems of the occurrence of crack or breaking when treating the composite sheet at a high temperature since a cured product from the conventional silicone materials has high thermal expansion coefficient over the glass fiber.

### DISCLOSURE

### Technical Problem

One aspect of the present invention is to provide a composite sheet having high thermal stability without the occurrence of crack or breaking when treating it at a high temperature.

Another aspect of the present invention is to provide a composition for composite sheets capable of easily controlling elongation and modulus.

### Technical Solution

A composition for composite sheets of the present invention may comprise a linear silicone rubber and a crosslinking agent, wherein a matrix prepared from the composition for composite sheets may have a tensile elongation of the matrix of about 15% or more.

A composite sheet of the present invention may comprise a reinforcing material and a matrix, in which the reinforcing material may be impregated, prepared from the composition for composite sheets.

A display apparatus of the present invention may comprise a substrate, and an element for apparatuses formed on the substrate, wherein the substrate may comprise the composite sheet.

### Advantageous Effects

The present invention provides a composite sheet having high thermal stability without the occurrence of crack or breaking when treating it at a high temperature.

The present invention provides a composition for composite sheets capable of easily controlling elongation and modulus.

### DESCRIPTION OF DRAWINGS

FIG. 1 is a schematic cross-sectional view of a composite sheet according to one aspect of the present invention.

FIG. 2 is a schematic cross-sectional view of a composite sheet according to another aspect of the present invention.

FIG. 3 is a schematic cross-sectional view of a display apparatus according to one aspect of the present invention.

### BEST MODE

Hereinafter, embodiments of the present invention will be described in detail with reference to the accompanying drawings. It should be understood that the present invention may be embodied in different ways and is not limited to the following embodiments. In the drawings, elements irrelevant to the description will be omitted for clarity. Like components will be denoted by like reference numerals throughout the specification.

As used herein, the term “tensile elongation of matrix” means a value determined on the matrix specimen of 5 mm×20 mm×120 μm (width×length×thickness) prepared by thermally curing 2 g of the composition for composite sheets at 50° C. for 2 hours, as a percentage of a ratio of the length in which the matrix specimen breaks when stretching the matrix specimen in the direction of length using Instron (TA.XT Plus, TA instrument) at a rate of 50 mm/min to the initial length (length direction) of the matrix specimen.

As used herein, the term “modulus”, referring to the composite sheet, means a value calculated by applying a force of 10 mN per unit area (1 mm²) with a micro indenter (Vicker indenter) to the portion consisted of the matrix in the composite sheet (for example, the window portion in the composite sheet (a portion consisted of the resin, in which wefts and warps of glass fibers are not cross if the glass cloth is used as the reinforcing material)) for 10 seconds, and creeping for 3 seconds and relaxing for 10 seconds.

Hereinafter, a composition for composite sheets according to one aspect of the present invention will be described.

A composition for composite sheets of one aspect of the present invention may be used for forming a matrix in which a reinforcing material is impregnated, and comprise a linear silicone rubber and a cross-linker. The linear silicone rubber may alleviate the difference between the thermal expansion of the matrix and the thermal expansion of the reinforcing material by increasing the tensile elongation of the matrix even though treating the composite sheet at a high temperature and thus may not lead to the crack or breaking when treating it at a high temperature. Furthermore, it is possible to easily controlling elongation and modulus of the composite sheet by adjusting the ratio of the siloxane monomer because the linear silicone rubber has a structure in which the siloxane units are linked.

The linear silicone rubber may be a siloxane resin having a curable functional group, for example, a copolymer comprising a first repeat unit having a curable functional group and at least one second repeat unit not having a curable functional group. Specifically, the siloxane resin having the curable functional group may be formed via the polymerization of the first silicone monomer having the curable functional group and at least one second silicone monomer not having the curable functional group, and the first silicone monomer having the curable functional group may be present in an amount of about 5.0 wt % or less, for example, about 0.01 wt % to about 1.0 wt %, and particularly about 0.1 wt %, about 0.2 wt %, about 0.3 wt %, about 0.4 wt %, about 0.5 wt %, about 0.6 wt %, about 0.7 wt %, about 0.8 wt %, about 0.9 wt % or about 1.0 wt % in the monomer mixture (the total of the first silicone monomer and the second silicone monomer). Within this range, it is possible to increase the tensile elongation of the matrix to increase the thermal stability of the composite by adding the curable functional group as a crosslinking site at certain extent. The “curable functional group” is a functional group capable of crosslinking, and may be an unsaturated C₂-C₁₂ hydrocarbon group having an unsaturated bond at the terminal, for example, a vinyl group or an allyl group.

In addition, the linear silicone rubber may be a linear siloxane oligomer or polymer having a curable functional group, and an aliphatic hydrocarbon group, and/or an aromatic hydrocarbon group, and the like. The aliphatic hydrocarbon group, aromatic hydrocarbon group, and the like serve to support the matrix and build up the bonding between the matrix and the reinforcing material, and particularly the aromatic hydrocarbon group serves to increase the light transmittance of the composite sheet by matching the refractive index of the reinforcing material and the matrix. Specifically, the linear silicone rubber may comprise repeat units of Formulae 1, 2, and 3:

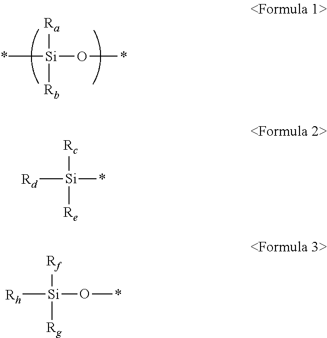

(wherein Formula 1 to Formula 3, * is a linking site of an element, Rₐ, R_{b}, R_{c}, R_{d}, Rₑ, R_{f}, R_{g}, and Rₕ are each independently hydrogen, a C₁-C₁₀ alkyl group, a C₆-C₂₀ aryl group, a C₇-C₂₀ arylalkyl group, or an unsaturated C₂-C₁₂ hydrocarbon group having a double bond at the terminal, and at least one of Rₐ, R_{b}, R_{c}, R_{d}, Rₑ, R_{f}, R_{g}, and Rₕ are an unsaturated C₂-C₁₂ hydrocarbon group having a double bond at the terminal). More specifically, the linear silicone rubber may comprise a repeat unit of Formula 1 and repeat units of Formulae 2 and 3 at the terminal.

For example, the linear silicone rubber may be a polydimethylsiloxane (PDMS) containing vinyl group. The polydimethylsiloxane containing vinyl group may be prepared from a composition for preparing the linear silicone rubbers comprising vinylmethyldimethoxy silane (VMDMS) as the first silicone monomer having the curable functional group, and phenylmethyldimethoxysilane (PMDMS) and dimethyldimethoxysilane (DMDMS) as the second silicone monomer having the curable functional group. Specifically, the polydimethylsiloxane containing vinyl group may be prepared by hydrolysis, polymerization and end capping reaction of PMDMS, DMDMS and VMDMS. VMDMS may be present in an amount of about 5.0 wt % or less, for example, about 0.01 wt % to about 1.0 wt %, for example, about 0.1 wt %, about 0.2 wt %, about 0.3 wt %, about 0.4 wt %, about 0.5 wt %, about 0.6 wt %, about 0.7 wt %, about 0.8 wt %, about 0.9 wt % or about 1.0 wt % based on the total amount of PMDMS, DMDMS and VMDMS. Within this range, it is possible to maximize the tensile elongation of the matrix, and decrease the occurrence of crack of the composite sheet at a high temperature by adding the curable functional group as a crosslinking site at certain extent. PMDMS may be present in an amount of about 10 wt % to about 80 wt %, and DMDMS may be present in an amount of about 10 wt % to about 90 wt %, and particularly about 19 wt % to about 85 wt % according to the desired refractive index based on the total amount of PMDMS, DMDMS and VMDMS. Within this range, the desired refractive index of the composite sheet will be achieved. The hydrolysis may be carried out by mixing PMDMS, DMDMS and VMDMS and reacting the resulting mixture with certain base, specifically NaOH, KOH, and the like as a strong base, at about 50° C. to about 100° C. for about 10 minutes to about 7 hours. Within this range, it is possible to increase the efficacy of the hydrolysis of PMDMS and DMDMS. The polymerization may be carried out at about 50° C. to about 100° C. for about 10 minutes to about 7 hours, and a polymerization catalyst may be used in order to increase the efficacy of the polymerization. The polymerization may be carried out after separating the product obtained after the hydrolysis, or alternatively may be carried out in situ. The end capping may serve to cap the Si terminal site in the product, and the examples of the end capping agent are 1,3-divinyltetramethyldisiloxane or hexamethyldisiloxane, and the like. The end capping may be carried out at about 20° C. to about 100° C. for about 10 minutes to about 7 hours.

The polydimethylsiloxane containing vinyl group may comprise a repeat unit of Formula 4 and may be represented by Formulae 5 or Formula 6:

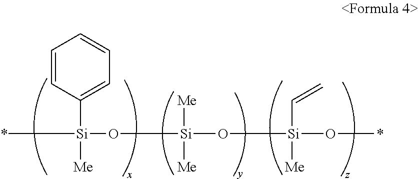

(wherein Formula 4, * is a linking site of an element, 0<x<1, 0<y<1, 0≦z≦1, and Me is a methyl group).

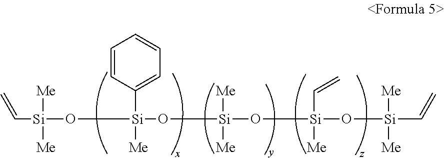

(wherein Formula 5, 10≦x≦400, 10≦y≦700, 0≦z≦700 (integer), and Me is a methyl group)

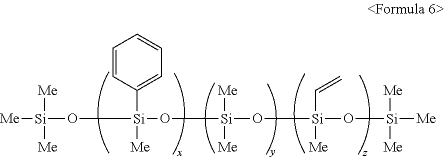

(wherein Formula 6, 10≦x≦400, 10≦y≦700, 0≦z≦700 (integer), and Me is a methyl group).

The linear silicone rubber may have a number average molecular weight (Mn) of about 2,000 to 50,000 g/mol. Within this range, it is possible to support the matrix.

The cross-linker may be a single molecular having two or more of —Si—H groups or oligomer thereof, capable of hydrosilylating with the curable functional group of the linear silicone rubber by activated by heat or UV. Furthermore, the cross-linker may achieve excellent miscibility with the linear silicone rubber, and high heat resistance because it has the siloxane units as the linear single molecule or oligomer.

For example, the cross-linker may comprise compounds represented by Formulae 7, 8, and 9:

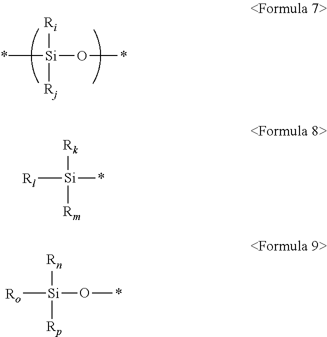

(wherein Formula 7 to Formula 9, * is a linking site of an element, Rᵢ, Rⱼ, Rₖ, Rₗ, Rₘ, Rₙ, Rₒ, and Rₚ are each independently hydrogen, a C₁-C₁₀ alkyl group, a C₆-C₂₀ aryl group, or a silyloxy group, and two or more of Rᵢ, Rⱼ, Rₖ, Rₗ, Rₘ, Rₙ, Rₒ, and Rₚ are hydrogen). The “silyloxy group” means a —Si—O— group having a C₁-C₁₀ alkyl group or hydrogen. In other words, while the cross-linker may comprise the repeat unit of Formula 7, the terminal may comprise compounds of Formula 8 and Formula 9.

Specifically, the cross-linker may be a compound selected from the group consisting of compounds represented by any one of Formulae 10 to 14, and oligomers of Formula 15, or mixtures thereof:

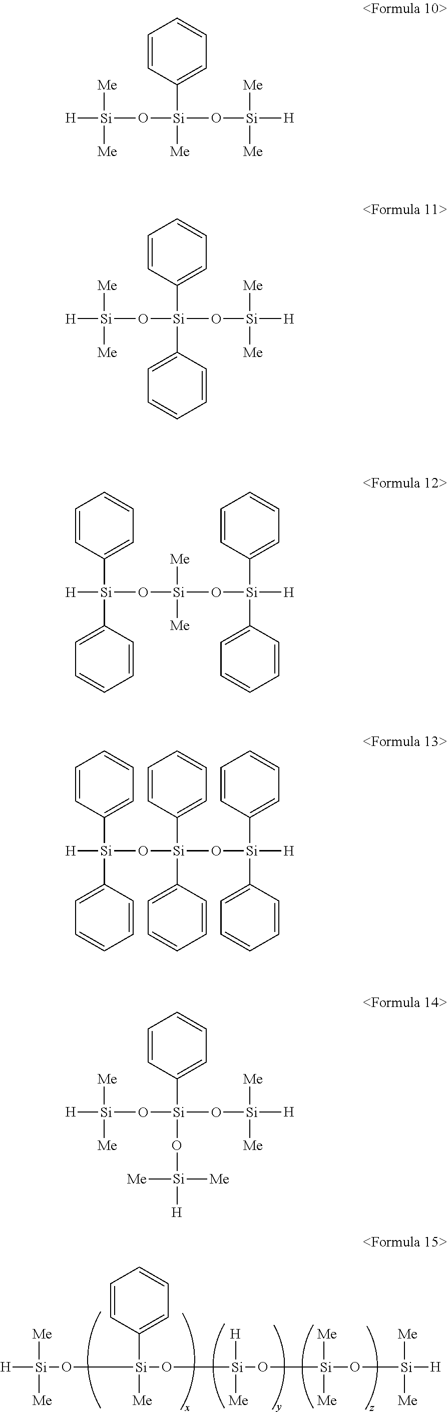

(wherein Formula 15, 0≦x≦30, 0≦y≦40, 0≦z≦40 (integer), and Me is a methyl group). The cross-linker of Formula 15 may have a number average molecular weight (Mn) of about 200 to 3,000 g/mol. Within this range, it is possible to secure excellent miscibility with resins such as the linear silicone rubber, and the like, and high curing efficiency.

The cross-linker may be commercially available products, or may be prepared by any typical method.

The linear silicone rubber may be present in an amount of about 80 wt % to about 99 wt %, for example, about 80 wt %, about 81 wt %, about 82 wt %, about 83 wt %, about 84 wt %, about 85 wt %, about 86 wt %, about 87 wt %, about 88 wt %, about 89 wt %, about 90 wt %, about 91 wt %, about 92 wt %, about 93 wt %, about 94 wt %, about 95 wt %, about 96 wt %, about 97 wt %, about 98 wt % or about 99 wt %, and the cross-linker may be present in an amount of about 1 wt % to about 20 wt %, for example, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt % or about 20 wt %, on the solid contents in the composition for composite sheets. Within this range, it is possible to secure the elongation of the matrix and increase the thermal stability of the composite sheet.

If a ratio of mole number of silicone-curable functional group (for example, Si-vinyl group) in the linear silicone rubber to the weight average molecular weight of the linear silicone rubber is referred to A, and a ratio of mole number of silicone-H (Si—H) in the cross-linker to the (weight) average molecular weight of the cross-linker is referred to B in the composition for composite sheets of one aspect of the present invention, A:B may be about 1:1 to about 1:3, for example, about 1:1 to about 1:2. Within this range, it is possible to secure the compressive elongation of the composite sheet and increase thermal stability of the composite sheet.

The composition for composite sheets of one aspect of the present invention may further comprise at least one of a catalyst and an inhibitor.

The catalyst may serve to increase the rate of the crosslinking reaction, and may be any catalyst typically used in the preparation of the composite sheet. For example, the catalyst may be, as the platinum or rhodium catalyst, a complex of platinum and organic compounds, a complex of platinum and vinylated organosiloxanes, a complex of rhodium and olefins, cyclopentadienyl-platinum complex, and the like. Particularly, if the cyclopentadienyl platinum catalyst is used, it is possible to prevent the curing of the composition for composite sheets at an ambient temperature to increase the storage stability. Specifically, the catalyst may be vinylalkyl silane platinum complex comprising a Karstedt's catalyst, platinum black, chloroplatinic acid, chloroplatinic acid-olefin complex, chloroplatinic acid-alcohol complex, trimethyl (methylcyclopentadienyl)platinum (IV) or mixtures thereof. The catalyst may be present in an amount of about 2 ppm to 2,000 ppm, for example, about 5 ppm to 500 ppm based on the weight of metals in the linear silicone rubber. Within this range, it is possible to increase sufficiently the rate of the crosslinking reaction, and eliminate the use of the unnecessary catalyst.

The inhibitor may suppress the action of the catalyst at an ambient temperature and not suppress the action of the catalyst at a high temperature in order to cure the matrix composition at a high temperature, and may be any inhibitor typically used in the preparation of the composite sheet. For example, the inhibitor may be selected from the group consisting of acetylenic alcohol such as 3,5-dimethyl-1-hexyn-3-ol, etc., pyridine, phosphine, organic phosphite, unsaturated amide, dialkyl carboxylate, dialkyl acetylene dicarboxylate, alkylated maleate, diallyl maleate, or mixtures thereof. The inhibitor may be present in an amount of about 100 ppm to 2,500 ppm in the linear silicone rubber. Within this range, it is possible to suppress the catalyst over the temperature, and control curing at a high temperature.

The composition for composite sheets of one embodiment of the present invention may further comprise any resin typically used in the composition for composite sheets. Specifically, the resin may include epoxy resin, acryl resin, polyamide resin, styrenic resin, etc., provided that the resin is added to the extent not deteriorating the physical property of the linear silicone rubber and the cross-linker, and specifically the resin may be present in an amount of about 10 parts by weight to about 20 parts by weight based on 100 parts by weight of the linear silicone rubber.

The composition for composite sheets of one embodiment of the present invention may have a viscosity of about 10 cps to about 500 cps at 25° C. Within this range, it is possible to prepare easily the composite sheet since the reinforcing material is impregnated.

The composition for composite sheets of another embodiment of the present invention may comprise the linear silicone rubber, the cross-linker, and a non-rubber silicone compound. Since the composition for composite sheets of another embodiment of the present invention further comprises the non-rubber silicone compound, it is possible to decrease the viscosity of the composition for composite sheets to easily form the sheet and match the refractive index with the reinforcing material, and control easily the modulus of the composite sheet by controlling a ratio of the mole number of the linear silicone rubber and the non-rubber silicone compound. Furthermore, if the composition for composite sheets is cured simultaneously with the linear silicone rubber, it is possible to prepare the composite sheet having high thermal stability due to improved heat resistance. The composition for composite sheets according to another embodiment is the same as the composition for composite sheets according to one embodiment except that the composition comprises the non-rubber silicone compound. Hereinafter, the non-rubber silicone compound will be described in detail.

The non-rubber silicone compound may be, for example, a cyclic siloxane compound. The cyclic siloxane compound may have a structure in which the siloxane units are linked in a ring form and increase the modulus of the composite sheet. The cyclic siloxane compound may comprise a curable functional group, and an aliphatic hydrocarbon group and/or an aromatic hydrocarbon group, and the curable functional group may be an unsaturated C₂-C₁₂ hydrocarbon group having a double bond at the terminal, for example, a vinyl group, or an allyl group.

In one embodiment, the cyclic siloxane compound may be a cyclic siloxane compound in which 3 to 10 of same or different siloxane units are linked, for example, compounds in which the curable functional group, and the like is linked to at least one silicone selected cyclotrisiloxane, cyclotetrasiloxane, cyclopentasiloxane, cyclohexasiloxane, cycloheptasiloxane, or cyclooctasiloxane. For example, the cyclic siloxane compound may comprise tetravinyltetramethyl cyclotetrasiloxane, a derivative of tetravinyltetramethyl cyclotetrasiloxane, a derivative of tetrazmethyl cyclotetrasiloxane, and the like.

In one embodiment, the cyclic siloxane compound may be represented by Formula 16:

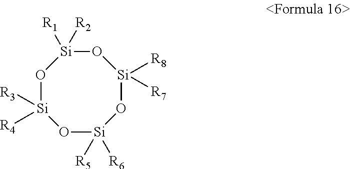

(wherein Formula 16, R₁, R₂, R₃, R₄, R₅, R₆, R₇, and R₈ are each independently a C₁-C₁₀ alkyl group, a C₆-C₂₀ aryl group, a vinyl group, an allyl group, an allyloxy group, a vinyloxy group, or Formula 17,

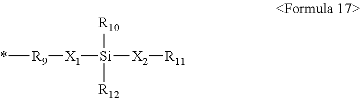

(wherein Formula 17, * is a linking site of Si in Formula 16,

R₉ is a C₁-C₁₀ alkylene group, or a C₆-C₂₀ arylene group, R₁₀, R₁₁, and R₁₂ are each independently a C₁-C₁₀ alkyl group, a C₆-C₂₀ aryl group, a vinyl group, an allyl group, an allyloxy group, or a vinyloxy group, and X₁ and X₂ are each independently a single bond, O, S, or NR, wherein R is hydrogen or a C₁-C₁₀ alkyl group),

at least one of R₁, R₂, R₃, R₄, R₅, R₆, R₇, and R₈ are a vinyl group, an allyl group, an allyloxy group, a vinyloxy group, Formula 17 in which at least one of R₁₀, R₁₁, and R₁₂ are a vinyl group, Formula 17 in which at least one of R₁₀, R₁₁, and R₁₂ are an allyl group, Formula 17 in which at least one of R₁₀, R₁₁, and R₁₂ are an allyloxy group, or Formula 17 in which at least one of R₁₀, R₁₁, and R₁₂ are a vinyloxy group).

The derivative may be prepared by any typical method. For example, the derivative may be prepared by substituting alkyl group with halogenated alkyl group or changing vinyl group in tetravinyl tetraalkyl cyclotetrasiloxane, and then reacting the substituted product with a compound containing one or more curable functional groups, for example, allyl alcohol, vinyl alcohol, and the like under the Karstedt's platinum catalyst.

Specifically, the cyclic siloxane compound may be represented by Formula 18 to Formula 43, but not limited thereto:

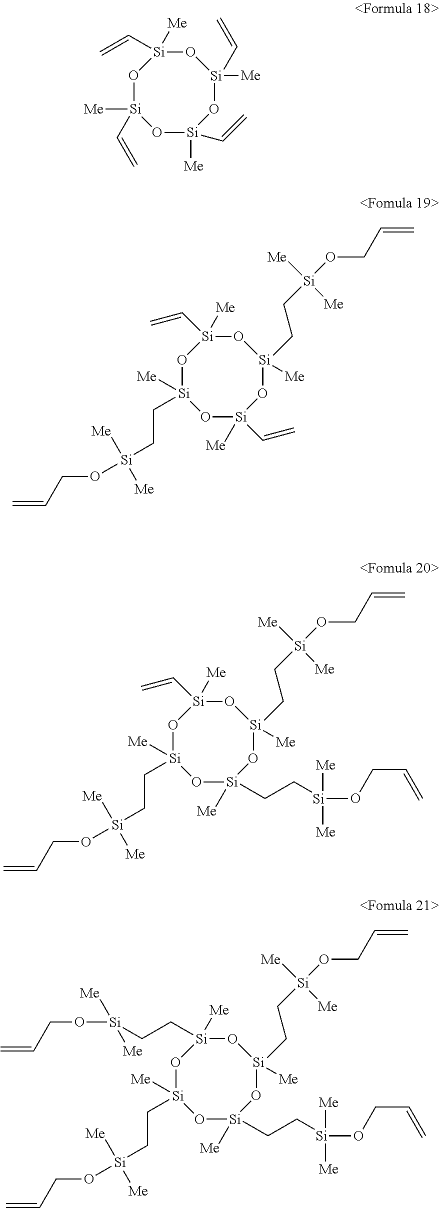

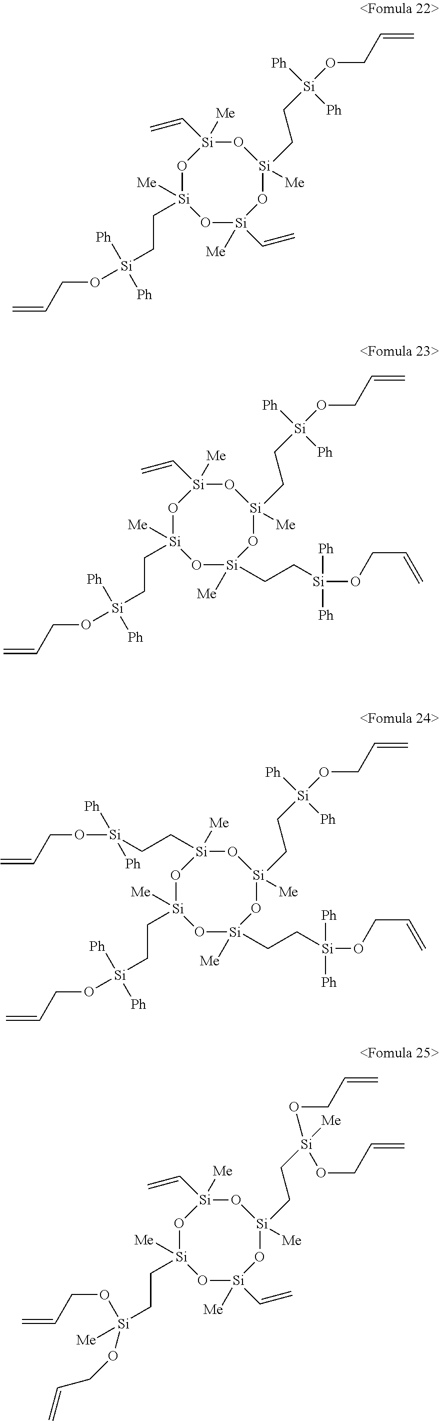

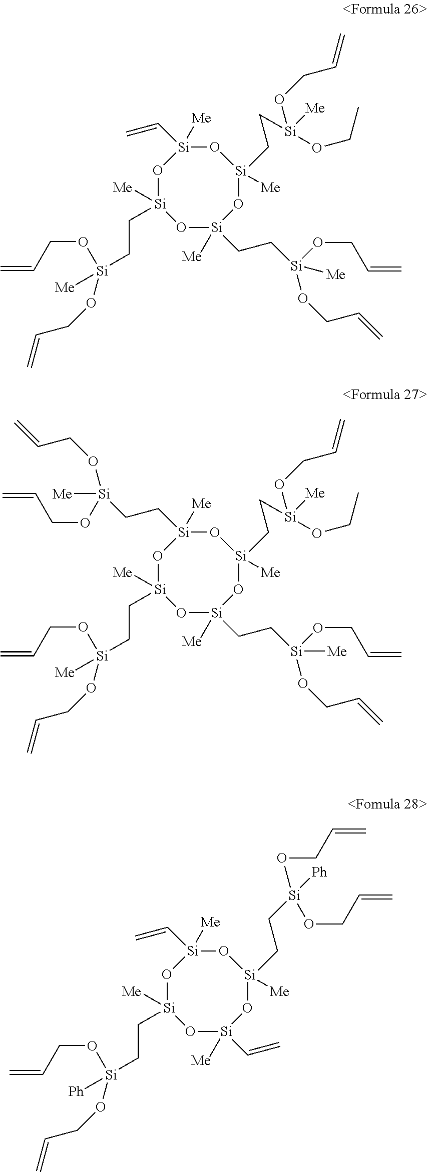

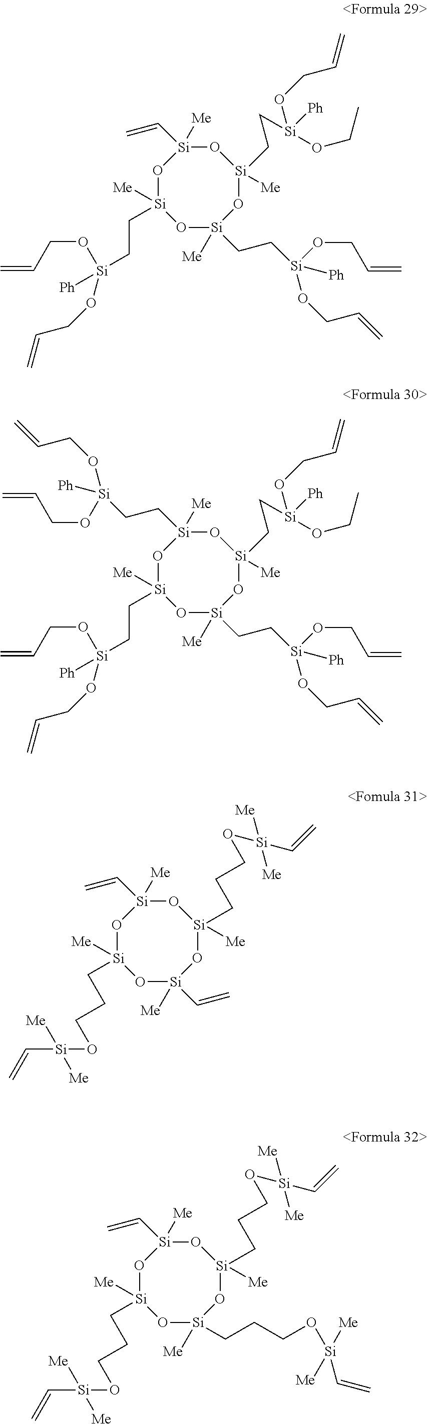

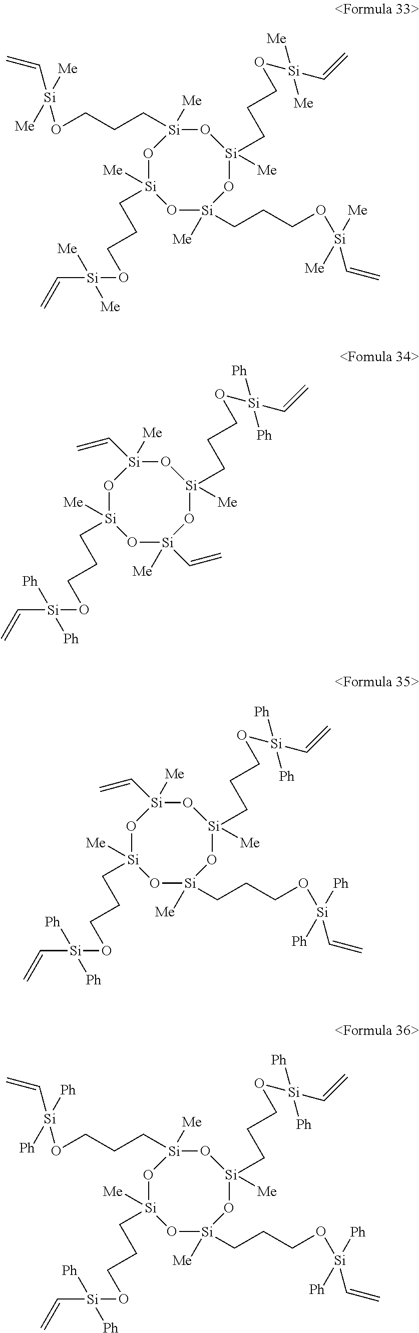

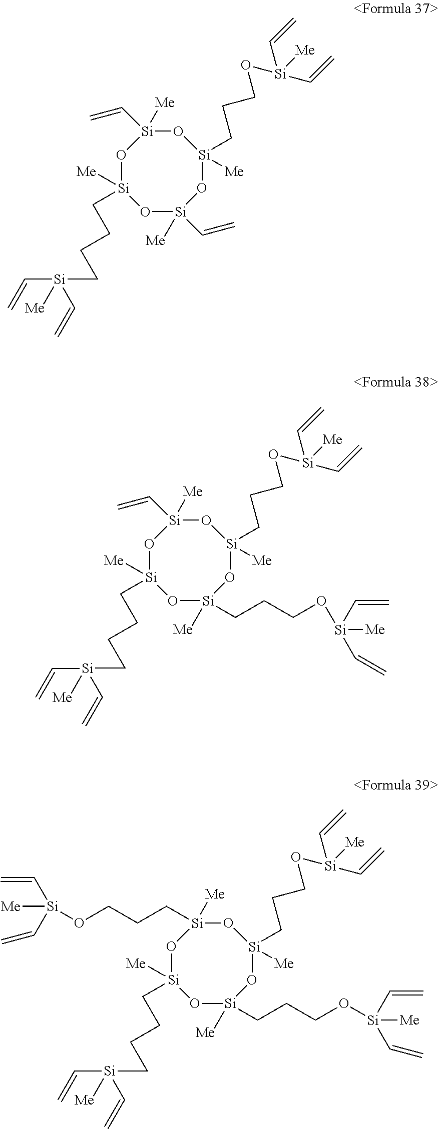

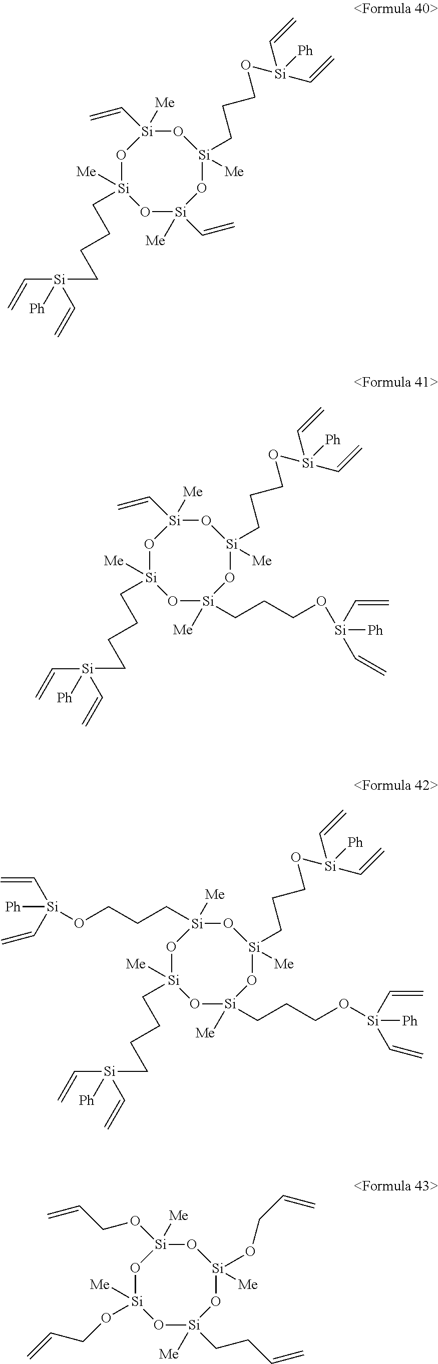

(wherein Formula 18 to Formula 43, Me is a methyl group, and Ph is a phenyl group).

If a ratio of mole number of silicone-curable functional group (for example, Si-vinyl group) in the non-rubber silicone compound to the molecular weight of the non-rubber silicone compound is referred to C, and a ratio of mole number of silicone-curable functional group (for example, Si-vinyl group) in the linear silicone rubber to the weight average molecular weight of the linear silicone rubber is referred to A, C:A may be about 1:1 to about 6:1, for example, about 3:1 to about 6:1. Within this range, it is possible to secure the compressive elongation of the composite sheet and increase thermal stability of the composite sheet while retaining certain modulus. In addition, if a ratio of mole number of silicone-H (Si—H) in the cross-linker to the (weight) average molecular weight of the cross-linker is referred to B, (A+C):B may be about 1:1 to about 1:3, for example about 1:1 to about b1:2. Within this range, it is possible to secure the compressive elongation of the composite sheet and increase thermal stability of the composite sheet while retaining certain modulus.

The linear silicone rubber of another embodiment of the present invention may be present in an amount of about 60 wt % to about 96 wt %, for example, about 60 wt %, about 61 wt %, about 62 wt %, about 63 wt %, about 64 wt %, about 65 wt %, about 66 wt %, about 67 wt %, about 68 wt %, about 69 wt %, about 70 wt %, about 71 wt %, about 72 wt %, about 73 wt %, about 74 wt %, about 75 wt %, about 76 wt %, about 77 wt %, about 78 wt %, about 79 wt %, about 80 wt %, about 81 wt %, about 82 wt %, about 83 wt %, about 84 wt % %, about 85 wt %, about 86 wt %, about 87 wt %, about 88 wt %, about 89 wt %, about 90 wt %, about 91 wt %, about 92 wt %, about 93 wt %, about 94 wt %, about 95 wt % or about 96 wt %, and the non-rubber silicone compound may be present in an amount of about 1 wt % to about 30 wt %, for example, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt % or about 30 wt %, and the cross-linker may be present in an amount of about 1 wt % to about 20 wt %, for example, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt % or about 20 wt %, on the solid contents in the composition for composite sheets. Within this range, it is possible to increase the compressive elongation of the composite sheet, and prevent the decrease in the transmittance of the composite sheet due to the unreacted materials.

The matrix specimen prepared from the composition for composite sheets according to some embodiments of the present invention may have a tensile elongation of about 15% or more, for example, about 15% to about 40%. If the matrix has a tensile elongation of less than 15%, the composite sheet may have deteriorated thermal stability and heat resistance, and thus the composite sheet will crack, and have poor flexibility, and split in the interface of the matrix and the reinforcing material when treating the composite sheet at a high temperature. In addition, certain components or layers may be peeled if the components or layers are laminated on the upper surface of the matrix.

Moreover, the matrix prepared from the composition for composite sheets according to some embodiments of the present invention may have a thermal expansion coefficient of about 10 ppm/° C. or less, and particularly about 3 ppm/° C. to about 7 ppm/° C. according to ASTM E 831 method. The composition for composite sheets according to some embodiments of the present invention may alleviate the difference of the thermal expansion coefficient between the matrix and the reinforcing material such that the problems of the occurrence of crack when treating the composite sheet at a high temperature can be addressed. Specifically, the difference of the thermal expansion coefficient between the matrix prepared from the composition for composite sheets and the reinforcing material according to ASTM E 831 method may be about 0.1 ppm/° C. to about 5 ppm/° C. Within this range, it is possible to prevent crack or breaking in the treatment at a high temperature since the composite sheet has high thermal stability. The reinforcing material may have a thermal expansion coefficient of about 10 ppm/° C. or less, and particularly about 3 ppm/° C. to about 7 ppm/° C. according to ASTM E 831 method.

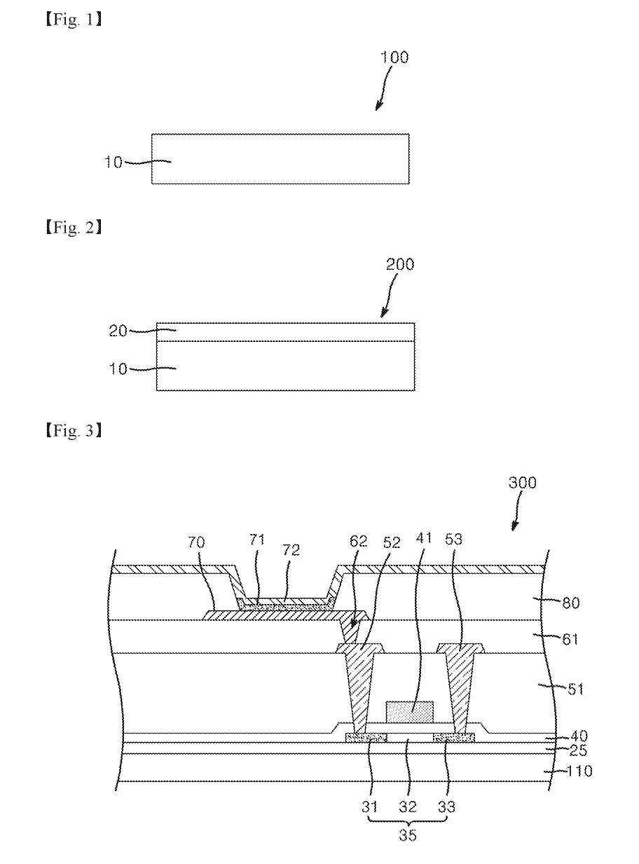

Hereinafter, referring to FIG. 1, a composite sheet according to one aspect of the present invention will be described. FIG. 1 is a schematic cross-sectional view of a composite sheet according to one aspect of the present invention.

Referring to FIG. 1, a composite sheet 100 according to one aspect of the present invention may comprise a matrix 10, and a reinforcing material (not shown in FIG. 1) impregnated in the matrix 10, and the matrix 10 may be formed from the composition for composite sheets according to some embodiments of the present invention.

Therefore, the composite sheet 100 may have high thermal stability and a transmittance of about 80% or more at 25° C. and at a wavelength of 550 nm after allowing it left at 250° C. for 1 hour on a thickness of 100 μm. If the composite sheet is used in the TFT process comprising treating the composite sheet repeatedly at a high temperature of about 250° C. or more, the composite sheet cannot be used as the substrates when it cracks and the transmittance is less than 80%.

Furthermore, the composite sheet 100 may have a modulus of about 0.1 MPa to about 30 MPa, for example, about 1 MPa to about 20 MPa. Within this range, certain components or layers will not be delaminated even though the components or layers are laminated on the upper surface of the composite sheet. Generally, although the higher modulus of the composite sheet has, the lower compressive elongation of the composite sheet has, the composite sheet of the present invention may secure high compressive elongation and certain range of modulus, and thus secure the effect due to the thermal stability and modulus of the composite sheet.

The composite sheet 100 may have a surface roughness (Ra) of about 100 nm or less, particularly about 50 nm or less, and more particularly about 5 nm to 50 nm, and the composite sheet 100 may have a thermal expansion coefficient of about 0 ppm/° C. to 400 ppm/° C., particularly about 0 ppm/° C. to 10 ppm/° C., and more particularly about 3 ppm/° C. to 7 ppm/° C. Within this range, the thermal strain will be suppressed when the composite sheet is prepared as the flexible substrate. The thermal expansion coefficient may be determined according to ASTM E 831 method by measuring the dimensional change over the temperature using a Thermo-mechanical analyser (expansion mode, force 0.05 N) from the curve of the change in length of the specimen verse the temperature (30 to 250° C.). Within this range, the composite sheet may be used as the flexible substrate. The composite sheet may be transparent in the region of visible light.

The matrix 10 may have a tensile elongation of about 15% or more, for example, about 15 to about 40%. Within this range, the composite sheet may have excellent thermal stability, heat resistance and flexibility, and will not crack under the treatment at a high temperature and will not split in the interface of the matrix and the reinforcing material. Moreover, the composite sheet will not be delaminated even though components or layers are laminated on the upper surface of the composite sheet.

The matrix 10 may be present in an amount of about 30 wt % to about 50 wt %, for example, about 30 wt % to about 40 wt % in the composite sheet. Within this range, it is possible to secure the high heat resistance and mechanical properties of the flexible substrate, and increase transparency, flexibility, and lightness as well as provide flexibility with the composite sheet.

The reinforcing material may be embedded in the matrix 10, and particularly may be embedded in the matrix via the dispersion into a mono-layer or a multi-layer structure. Although not illustrated in FIG. 1, the reinforcing material may be impregnated in the matrix in a lamellar form, dispersed in the matrix, impregnated in the woven form, or impregnated uni-directionally. Furthermore, the reinforcing material may be formed into a mono-layer or a multi-layer.

The reinforcing material may be present in an amount of about 50 wt % to about 80 wt % in the composite sheet. Within this range, it is possible to secure high heat resistance and mechanical properties of the flexible substrate, and increase transparency, flexibility, and lightness as well as provide flexibility with the composite sheet.

The reinforcing material may have a refractive index difference (an absolute value of the refractive index of the reinforcing material—the refractive index of the matrix) with the matrix 10 of about 0.01 or less. Within this range, it is possible to achieve excellent transparent and translucency. For example, the refractive index difference may be about 0 to about 0.005, for example, about 0.0001 to about 0.005. Specifically, it is possible to use the reinforcing material having a refractive index of about 1.6 or less, and particularly about 1.45 to 1.55. The reinforcing material having a refractive index of about 1.5 or less may have low refractive index difference with the silicone matrix, and thus secure transparency of the composite sheet. Further, it is possible to use the reinforcing material having a thermal expansion coefficient of about 10 ppm/° C. or less, and particularly about 3 to about 7 ppm/° C. If such reinforcing material may be used, the composite sheet may have low thermal expansion coefficient, and thus improvement in heat resistance. The thermal expansion coefficient may be determined from the curve of length change of the specimen over the temperature (30 to 250° C.) by measuring the dimensional change over the temperature using a Thermo-mechanical analyser (expansion mode, force 0.05 N) according to ASTM E 831 method. Specifically, at least one selected from the group consisting of glass fibers, glass fiber clothes, glass fabrics, glass non-woven clothes and glass meshes may be used as the reinforcing material.

A process of preparing the composite sheet according to one aspect of the present invention may comprise impregnating a reinforcing material in the composition for composite sheets and curing the composition, and the curing may comprise at least one of thermal curing and photocuring. The thermal curing may be carried out at about 30 to about 100° C. for about 1 to about 3 hours, but not limited thereto. The photocuring may be carried out by irradiating at doses of UV wavelength of about 10 mJ/cm² to about 3000 mJ/cm², but not limited thereto.

Hereinafter, referring to FIG. 2, a composite sheet according to another aspect of the present invention will be described. FIG. 2 is a schematic cross-sectional view of a composite sheet according to another aspect of the present invention.

Referring to FIG. 2, a composite sheet 200 according to another aspect of the present invention may comprise matrix 10, a reinforcing material (not shown in FIG. 1) impregnated in the matrix 10 and a barrier layer 20 formed on the upper surface of the matrix 10, and the matrix 10 may be formed from the composition for composite sheets according to some embodiments of the present invention. A composite sheet according to another aspect of the invention is the same as the composite sheet 100 according to one aspect of the invention except that the barrier layer 20 is formed on the upper surface of the matrix 10. Hereinafter, the details of the barrier layer 20 will be described.

The barrier layer 20 may serve to prevent the penetration of impurities and moisture into the element below the barrier layer such as the matrix 10, and achieve the effect of maximizing moisture vapor permeability, mechanical properties, or smoothness. The barrier layer 20 may have a thickness of about 50 nm to about 500 nm. Within this range, it is possible to control excellent surface flatness and efficient moisture vapor permeability without influencing transmittance of the matrix.

The barrier layer 20 may comprise at least one of silicon nitride, silicon oxide, silicon carbide, aluminum nitride, indium tin oxide (ITO), or indium zinc oxide (IZO). Furthermore, two or more barrier layers may be formed as a mono-layer, or different barrier layers may be laminated to form a multi-layer. The barrier layer 20 may be formed on the surface of the coating layer by physical deposition, chemical deposition, coating, sputtering, evaporation, ion plating, wet coating, or organic inorganic multi-layer coating.

The barrier layer 20 may have a modulus of about 5 GPa to about 20 GPa, for example, about 10 GPa to about 20 GPa.

Hereinafter, a display apparatus according to one aspect of the present invention will be described.

A display apparatus of one aspect of the present invention may comprise the composite sheet of some embodiments of the present invention. The display apparatus may be, for example, but not limited thereto, flexible liquid crystal display apparatuses, flexible organic lighting device display apparatuses, and the like. The display apparatus may comprise a substrate and an element for apparatuses formed on the substrate, and the element for apparatuses may comprise organic lighting elements, liquid crystals, and the like.

Hereinafter, referring to FIG. 3, a display apparatus of one aspect of the present invention will be described. The display apparatus may be, for example, but not limited thereto, liquid crystal display apparatuses, organic lighting device display apparatuses, and the like. FIG. 3 shows organic lighting display apparatuses, but not limited thereto.

Referring to FIG. 3, a display apparatus 300 according to one aspect of the present invention may comprise a substrate 110, a buffer layer 25 formed on the upper surface of the substrate 110, a gate electrode 41 formed on the upper surface of the buffer layer 25, and a gate insulator film 40 formed between the gate electrode 41 and the buffer layer 25. An active layer 35 comprising a source and drain region 31, 32, 33 may be formed inside the gate insulator film 40. A interlayer insulator film 51, on which the source and drain electrode 52, 53 may be formed, may be formed on the supper surface of the gate insulator film 40, and a passivation layer 61 comprising contact holes 62, a first electrode 70, and a pixel defined layer 80 may be formed on the supper surface of the interlayer insulator film 51. An organic light emitting layer 71 and a second electrode 72 may be formed on the upper surface of the pixel defined layer 80, and substrate 110 may comprise the composite sheet according to aspects of the present invention.

### MODE FOR INVENTION

Now, the present invention will be described in more detail with reference to some examples. However, it should be noted that these examples are provided for illustration only and are not to be construed in any way as limiting the present invention.

### Preparation Example 1

### Preparation of the Linear Silicone Rubber

A linear silicone rubber was synthesized using phenylmethyldimethoxy silane (PMDMS), dimethyldimethoxy silane (DMDMS) and vinylmethyldimethoxy silane (VMDMS). After weighting PMDMS, DMDMS and VMDMS (PMDMS:DMDMS=3:2 (weight ratio), addition equivalent of VMDMS=0.5 wt % in PMDMS+DMDMS+VMDMS), hydrolysis was performed in a deionized water (DIW)/KOH at 70° C. for 1 hour. A polymerization reaction was carried out at 90° C., and toluene and H₂O were added to lower the temperature to 25° C. and flushed with H₂O. Thereafter, 1,3-divinyltetramethyldisiloxane (Vi-MM) was added, and subjected to the end capping at 50° C. for 5 hours, and flushed with H₂O at an ambient temperature, and solvent was removed using an evaporator to synthesize a final linear silicone rubber. The synthesized linear silicone rubber was a number average molecular weight (Mn) of 7,000 g/mol.

### Preparation Example 2

### Preparation of the Linear Silicone Rubber

A linear silicone rubber was prepared by the same method as Preparation Example 1 except that, in Preparation Example 1, the addition equivalent of VMDMS was changed to 1.0 wt %.

### Preparation Example 3

### Preparation of the Linear Silicone Rubber

A linear silicone rubber was prepared by the same method as Preparation Example 1 except that, in Preparation Example 1, the addition equivalent of VMDMS was changed to 2.0 wt %.

### Preparation Example 4

### Preparation of the Linear Silicone Rubber

A linear silicone rubber was prepared by the same method as Preparation Example 1 except that, in Preparation Example 1, the addition equivalent of VMDMS was changed to 3.0 wt %.

### Preparation Example 5

### Preparation of the Linear Silicone Rubber

A linear silicone rubber was prepared by the same method as Preparation Example 1 except that, in Preparation Example 1, the addition equivalent of VMDMS was changed to 5.0 wt %.

### Preparation Example 6

### Preparation of the Linear Silicone Rubber

A linear silicone rubber was prepared by the same method as Preparation Example 1 except that, in Preparation Example 1, the addition equivalent of VMDMS was changed to 0.6 wt %.

### Preparation Example 7

### Preparation of the Linear Silicone Rubber

A linear silicone rubber was prepared by the same method as Preparation Example 1 except that, in Preparation Example 1, the addition equivalent of VMDMS was changed to 0.7 wt %.

### Preparation Example 8

### Preparation of the Linear Silicone Rubber

A linear silicone rubber was prepared by the same method as Preparation Example 1 except that, in Preparation Example 1, the addition equivalent of VMDMS was changed to 2.1 wt %.

### Preparation Example 9

### Preparation of the Linear Silicone Rubber

A linear silicone rubber was prepared by the same method as Preparation Example 1 except that, in Preparation Example 1, the addition equivalent of VMDMS was changed to 2.2 wt %/o.

### Preparation Example 10

### Preparation of the Non-Rubber Silicone Compound

After 1,3,5,7-tetravinyl-1,3,5,7-tetramethyl cyclotetrasiloxane was dissolved in dichloromethane, a Karstedt's catalyst (Umicore) was added in small amounts. 2 equivalents of dimethylchlorosilane over 1,3,5,7-tetravinyl-1,3,5,7-tetramethyl cyclotetrasiloxane (i.e., 0.5 equivalents over the vinyl functional group) was added and stirred at 50° C. for 2 hours. Thereafter, 1.2 equivalents of trimethylamine are added at 0° C., and allyl alcohol are slowly added and stirred at 50° C. for 6 hours. After filtering through a paper filter, solids were removed and washed with a distilled water, and dichloromethane was removed to prepare a non-rubber silicone compound of Formula 19.

<Formula 19>

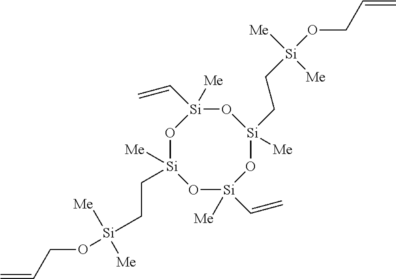 [SMILES: C=CCO[Si](C)(C)CC[Si]1(C)O[Si](C)(C=C)O[Si](C)(CC[Si](C)(C)OCC=C)O[Si](C)(C=C)O1]

### Example 1

The linear silicone rubber of Preparation Example 1 and a cross-linker (tris (dimethylsiloxy)phenyl silane, purity: 98% or more, JLCHEM Co., Ltd.) were combined such that a mole ratio of functional group A:B=1:1.2, and a Karstedt's catalyst (Umicore) and an inhibitor (Surfynol) were added to prepare a matrix composition. The content of the linear silicone rubber of Preparation Example 1 was 96 wt % in the composition for composite sheets. In the mole ratio of the functional group, A means a mole number of a Si-vinyl group to a weight average molecular weight of the linear silicone rubber, and B means a mole number of a Si—H group to a molecular weight of the cross-linker.

### Example 2

A composition for composite sheets was prepared by the same method as Preparation Example 1 except that, in Example 1, the linear silicone rubber in Preparation Example 2 was used instead of the linear silicone rubber in Preparation Example 1.

### Example 3

The linear silicone rubber of Preparation Example 1, a cross-linker (tris (dimethylsiloxy)phenyl silane, purity: 98% or more, JLCHEM Co., Ltd.), and tetravinyltetramethyl cyclotetrasiloxane (D4vinyl, purity: 95% or more, JLCHEM Co., Ltd.) as a non-rubber silicone compound were combined such that a mole ratio of functional group C:A=5.5:1 and (C+A):B=1:1.2, and a Karstedt's catalyst (Umicore) and an inhibitor (Surfynol) were added to prepare a matrix composition. The content of the linear silicone rubber of Preparation Example 1 was 68 wt % in the composition for composite sheets. In the mole ratio of the functional group, A means a mole number of a Si-vinyl group to a weight average molecular weight of the linear silicone rubber, B means a mole number of a Si—H group to a molecular weight of the cross-linker, and C means a mole number of a Si-vinyl group to a molecular weight of the non-rubber silicone compound.

### Example 4

A composition for composite sheets was prepared by the same method as the Example 3 except that, in Example 3, the content of the linear silicone rubber was changed to 73 wt % in the composition for composite sheets of C:A=4.1:1.

### Example 5

A composition for composite sheets was prepared by the same method as the Example 3 except that, in Example 3, the content of the linear silicone rubber was changed to 76 wt % in the composition for composite sheets of C:A=3.3:1.

### Example 6

A composition for composite sheets was prepared by the same method as the Example 3 except that, in Example 3, the non-rubber silicone compound in Preparation Example 10 was used instead of tetravinyltetramethyl cyclotetrasiloxane as the non-rubber silicone compound, and the content of the linear silicone rubber in Preparation Example 1 was changed to 96 wt % in the composition for composite sheets.

### Example 7

A composition for composite sheets was prepared by the same method as the Example 1 except that, in Example 1, the linear silicone rubber in Preparation Example 6 was used instead of the linear silicone rubber in Preparation Example 1.

### Example 8

A composition for composite sheets was prepared by the same method as the Example 1 except that, in Example 1, the linear silicone rubber in Preparation Example 7 was used instead of the linear silicone rubber in Preparation Example 1.

### Example 9

A composition for composite sheets was prepared by the same method as the Example 1 except that, in Example 1, 97 wt % of the linear silicone rubber in Preparation Example 1 was used.

### Example 10

A composition for composite sheets was prepared by the same method as the Example 1 except that, in Example 1, 98 wt % of the linear silicone rubber in Preparation Example 1 was used.

### Comparative Example 1

A composition for composite sheets was prepared by the same method as the Example 1 except that, in Example 1, the linear silicone rubber in Preparation Example 3 was used instead of the linear silicone rubber in Preparation Example 1.

### Comparative Example 2

A composition for composite sheets was prepared by the same method as the Example 1 except that, in Example 1, the linear silicone rubber in Preparation Example 4 was used instead of the linear silicone rubber in Preparation Example 1.

### Comparative Example 3

A composition for composite sheets was prepared by the same method as the Example 1 except that, in Example 1, the linear silicone rubber in Preparation Example 5 was used instead of the linear silicone rubber in Preparation Example 1.

### Comparative Example 4

A composition for composite sheets was prepared by the same method as the Example 1 except that, in Example 1, the linear silicone rubber in Preparation Example 8 was used instead of the linear silicone rubber in Preparation Example 1.

### Comparative Example 5

A composition for composite sheets was prepared by the same method as the Example 1 except that, in Example 1, the linear silicone rubber in Preparation Example 9 was used instead of the linear silicone rubber in Preparation Example 1.

The physical properties (1) to (2) were determined for the composite sheets of Examples and Comparative Examples, and the results thereof are shown in Table 1.

Furthermore, a glass fiber cloth (a refractive index: 1.48, a thermal expansion coefficient according to ASTM E 831: 3 ppm/° C., D-glass cloth, Owens Corning) was impregnated in the composition for composite sheets prepared in Examples 1 to 10 and Comparative Example 1 to 5 to be present at an amount of 60 wt % in the composite sheet, and thermally cured at 50° C. for 2 hours to prepare the composite sheet.

The physical properties (3) to (4) were determined for the prepared composite sheets, and the results thereof are shown in Table 1.

1. Tensile Elongation of Matrix: The tensile elongation was calculated on a matrix specimen of 5 mm×20 mm×120 μm (width×length×thickness) prepared by thermally curing 2 g of the composition for composite sheets at 50° C. for 2 hours, as a percentage of a ratio of the length in which the matrix specimen breaks when stretching the matrix specimen in the direction of length using Instron (TA.XT Plus, TA instrument) at a rate of 50 mm/min to the initial length (length direction) of the matrix specimen.

2. Modulus (Relaxation modulus): Modulus was calculated by applying a force of 10 mN to a window portion (a portion consisted of the resin, in which wefts and warps of glass fibers are not cross) of the composite sheet with a micro indenter (Vicker indenter) using a Micro indentation equipment (HM2000, Fisher) for 10 seconds, and creeping for 3 seconds, and relaxing for 10 seconds.

3. Transmittance: The transmittance in the initial state was measured on the composite sheet (thickness: 100 μm) at 25° C. and at a wavelength of 550 nm. After allowing the composite sheet left at 250° C. for 1 hour, the transmittance of the composite sheet was measured at 25° C. and at a wavelength of 550 nm. The transmittance was measured using an UV-Vis Spectrometer (Lambda 35, Perkin Elmer).

4. Occurrence of Crack: The occurrence of crack in the initial state was determined on the composite sheet at 25° C. using an optical microscope in reflection-mode. After allowing the composite sheet left at 250° C. for 1 hour, the occurrence of crack was determined in the same method as 25° C. If the crack was not occurred in the surface of the composite sheet, it is represented by “X”, and if the crack was partially occurred, it is represented by A, and if the crack was largely occurred, it is represented by “O”.

TABLE 1

| | Content | Content of | Tensile | | | | After leaving at | |
|---|---|---|---|---|---|---|---|---|
| | of | silicone | elongation | | Initial state | | 250° C. for 1 hour | |
| | VMDMS* | rubber** | (%) | Modulus | Transmittance | | Transmittance | |
| | (wt %) | (wt %) | of matrix | (MPa) | (%) | Crack | (%) | Crack |
| Ex. 1 | 0.5 | 96 | 25 | 5 | 88.0 | x | 88.2 | x |
| Ex. 2 | 1.0 | 96 | 21 | 5 | 86.9 | x | 87.0 | x |
| Ex. 3 | 0.5 | 68 | 18 | 10 | 88.4 | x | 88.2 | x |
| Ex. 4 | 0.5 | 73 | 20 | 7 | 87.5 | x | 88.1 | x |
| Ex. 5 | 0.5 | 76 | 24 | 4 | 87.8 | x | 86.9 | x |
| Ex. 6 | 0.5 | 96 | 27 | 7 | 87.6 | x | 87.2 | x |
| Ex. 7 | 0.6 | 96 | 25 | 5 | 87.9 | x | 88.0 | x |
| Ex. 8 | 0.7 | 96 | 25 | 5 | 88.1 | x | 87.9 | x |
| Ex. 9 | 0.5 | 97 | 25 | 5 | 87.8 | x | 88.1 | x |
| Ex. 10 | 0.5 | 98 | 26 | 5 | 87.6 | x | 87.9 | x |
| C.E. 1 | 2.0 | 96 | 14 | 7 | 87.5 | x | 77.4 | Δ |
| C.E. 2 | 3.0 | 96 | 11 | 8 | 81.0 | Δ | 53.0 | ∘ |
| C.E. 3 | 5.0 | 96 | 8 | 8 | 74.1 | ∘ | 49.2 | ∘ |
| C.E. 4 | 2.1 | 96 | 13 | 7 | 86.2 | x | 76.3 | Δ |
| C.E. 5 | 2.2 | 96 | 11 | 8 | 83.1 | Δ | 55.1 | ∘ |

*Content of VMDMS in the preparation of the linear silicone rubber according to Preparation Examples 1 to 9.
**Content of the linear silicone rubber on the solid contents in the matrix composition.

As shown in Table 1, it is demonstrated that the composition for composite sheets of the present invention had high tensile elongation of the matrix, and could provide a composite sheet without the occurrence of crack or the breaking when treating the composite sheet at a high temperature. In addition, referring to Examples 7 to 10, it is also shown that the modulus and/or elongation could be easily controlled because the variation in the modulus and/or elongation is low by adjusting the content of VMDMS and/or the content of linear silicone rubber.

However, it is demonstrated that Comparative Examples 1 to 3 having the addition equivalent of VMDMS outside the range of the present invention in the preparation of the linear silicone rubber led to the partial crack after allowing it left for 1 hour, and thus had a transmittance of less than 80%, and could not achieve the benefit of the present invention. In addition, referring to Comparative Examples 4 to 5, it is demonstrated that the modulus and/or elongation could not be easily controlled because the variation in the modulus and/or elongation is great by adjusting the content of VMDMS.

It is shown that the simple modifications or changes of the present invention can be easily practiced by those skilled in the art, and the modifications or changes will be encompassed by the scope of the present invention.

1. A composition for composite sheets comprising a linear silicone rubber and a cross-linker,
wherein a matrix prepared from the composition for composite sheets has a tensile elongation of about 15% or more.

2. The composition for composite sheets according to claim 1, wherein the linear silicone rubber is prepared from the composition comprising phenylmethyldimethoxysilane, dimethyldimethoxysilane and vinylmethyldimethoxysilane.

3. The composition for composite sheets according to claim 2, wherein the vinylmethyldimethoxysilane is present in an amount of about 1.0 wt % or less in the composition.

4. The composition for composite sheets according to claim 1, wherein the linear silicone rubber comprises a repeat unit of Formula 4: 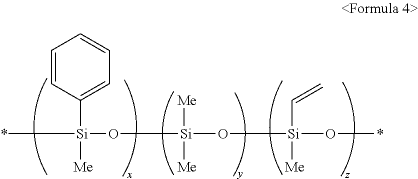
(wherein Formula 4, * is a linking site of an element, 0≦x≦1, 0≦y≦1, 0≦z≦1, x+y+z=1, and Me is a methyl group).

5. The composition for composite sheets according to claim 1, wherein the composition further comprises a non-rubber silicone compound.

6. The composition for composite sheets according to claim 5, wherein the non-rubber silicone compound is a cyclic siloxane compound.

7. The composition for composite sheets according to claim 6, wherein the cyclic siloxane compound is represented by Formula 16: 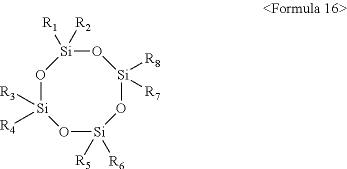
(wherein Formula 16, R₁, R₂, R₃, R₄, R₅, R₆, R₇, and R₈ are each independently a C₁-C₁₀ alkyl group, a C₆-C₂₀ aryl group, a vinyl group, an allyl group, an allyloxy group, a vinyloxy group, or Formula 17, 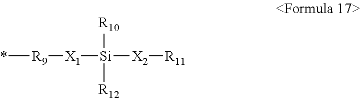
(wherein Formula 17, * is a linking site of Si in Formula 16,
R₉ is a C₁-C₁₀ alkylene group, or a C₆-C₂₀ arylene group, R₁₀, R₁₁, and R₁₂ are each independently a C₁-C₁₀ alkyl group, a C₆-C₂₀ aryl group, a vinyl group, an allyl group, an allyloxy group, or a vinyloxy group, and X₁ and X₂ are each independently a single bond, O, S, or NR, wherein R is hydrogen or a C₁-C₁₀ alkyl group),
at least one of R₁, R₂, R₃, R₄, R₅, R₆, R₇, and R₈ are a vinyl group, an allyl group, an allyloxy group, a vinyloxy group, Formula 17 in which at least one of R₁₀, R₁₁, and R₁₂ are a vinyl group, Formula 17 in which at least one of R₁₀, R₁₁, and R₁₂ are an allyl group, Formula 17 in which at least one of R₁₀, R₁₁, and R₁₂ are an allyloxy group, or Formula 17 in which at least one of R₁₀, R₁₁, and R₁₂ are a vinyloxy group).

8. A composite sheet comprising a reinforcing material and a matrix, in which the reinforcing material is impregated, prepared from the composition for composite sheets according to claim 1.

9. The composition for composite sheets according to claim 8, wherein the reinforcing material comprises at least one selected from the group consisting of glass fibers, glass fiber clothes, glass fabrics, glass non-woven clothes, and glass meshes.

10. The composition for composite sheets according to claim 8, further comprising a barrier layer formed on the composite sheet.

11. A display apparatus comprising;
a substrate, and an element for apparatuses formed on the substrate,
wherein the substrate comprises the composite sheet according to claim 8.
